(19) United States
(12) Patent Application Publication
(10) Pub. No.: US 2020/0398492 A1
(43) Pub. Date: Dec. 24, 2020

(54) METHOD FOR AUTONOMOUSLY GENERATING AN END EFFECTOR FOR INTERFACING WITH A PART AT A MANUFACTURING STATION

(71) Applicant: Carbon Robotics, Inc., San Francisco, CA (US)

(72) Inventors: Daniel Corkum, San Francisco, CA (US); Rosanna Myers, San Francisco, CA (US)

(21) Appl. No.: 16/890,997

(22) Filed: Jun. 2, 2020

Related U.S. Application Data
(60) Provisional application No. 62/863,226, filed on Jun. 18, 2019.

(51) Int. Cl. B29C 64/393; B25J 9/16; B25J 15/06

(52) U.S. Cl. CPC B29C 64/393; B33Y 50/02; B25J 15/0616; B25J 9/1605

(57) ABSTRACT

A method for autonomously generating an end effector for interfacing with a part at a manufacturing station includes: accessing a virtual model of an assembly and the part; based on the virtual model, identifying a set of unobstructed surfaces on the part when located in the assembly; selecting a target surface, from the set of unobstructed surfaces, on the part; calculating a virtual interaction surface spanning the target surface on the part defined in the virtual model; locating a virtual end effector base geometry relative to the virtual interaction surface; generating a virtual intermediate structure extending between the virtual interaction surface and the virtual base structure; compiling the virtual interaction surface, the virtual intermediate structure, and the virtual end effector base geometry into a three-dimensional end effector model; and queuing the three-dimensional end effector model for additive manufacturing to form the end effector for installation on a robotic arm.

### CROSS-REFERENCE TO RELATED APPLICATIONS

This Application claims the benefit of U.S. Provisional Application No. 62/863,226, filed on 18 Jun. 2019, which is incorporated in its entirety by this reference.

### TECHNICAL FIELD

This invention relates generally to the field of robotic arms and more specifically to a new and useful method for autonomously generating an end effector for interfacing with a part at a manufacturing station in the field of robotic arms.

### BRIEF DESCRIPTION OF THE FIGURES

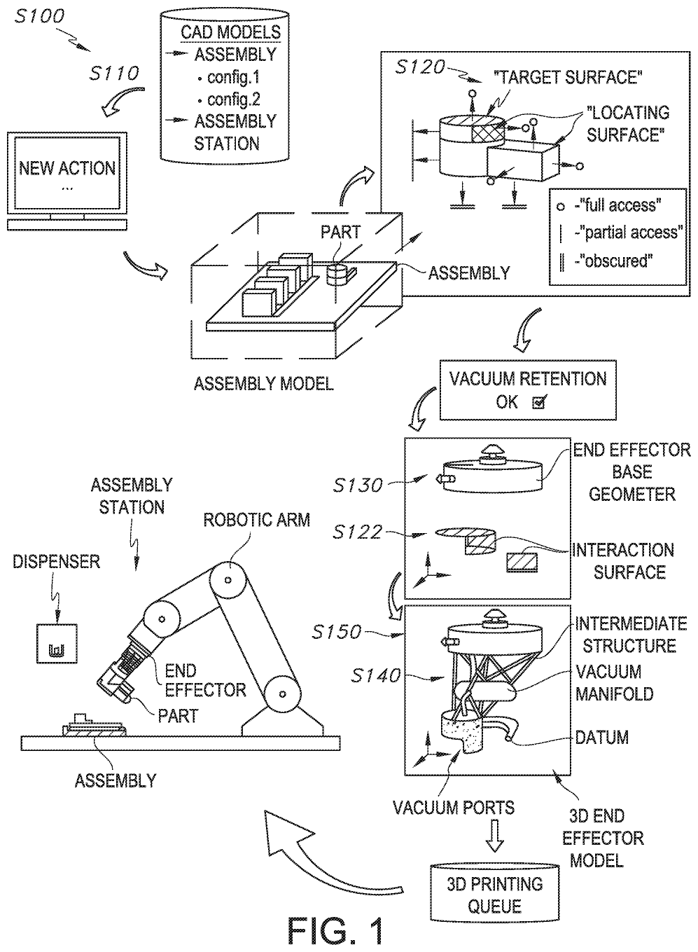

The FIG. 1s a flowchart representation of a method.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Method

As shown in the FIGURE, a method S100 for autonomously generating an end effector for interfacing with a part at a manufacturing station includes: accessing a virtual model of an assembly and the part in Block S110; based on the virtual model, identifying a set of unobstructed surfaces on the part when located in the assembly in Block S112; selecting a target surface, from the set of unobstructed surfaces, on the part in Block S120; calculating a virtual interaction surface that spans the target surface on the part defined in the virtual model in Block S122; locating a virtual end effector base geometry relative to the virtual interaction surface in Block S130; generating a virtual intermediate structure extending between the virtual interaction surface and the virtual base structure in Block S140; compiling the virtual interaction surface, the virtual intermediate structure, and the virtual end effector base geometry into a three-dimensional end effector model in Block S150; and queuing the three-dimensional end effector model for additive manufacturing to form the end effector for installation on a robotic arm when interfacing with units of the part and units of the assembly at the manufacturing station in Block S152.

### 2. Applications

Generally, the method S100 can be executed by a computer system (e.g., a remote server, a computer network, or a local desktop tablet computer executing a native or web application) to autonomously generate a 3D model of parametric tooling for interfacing a robotic arm to a part, assembly, part dispenser, jig, or fixture at an assembly station or other manufacturing scene based on virtual models of these objects. An end effector can then be manufactured (e.g., 3D-printed) based on this 3D model and subsequently installed on the end of this robotic arm to enable the robotic arm to perform motion or assembly steps with real units of this part, assembly, part dispenser, jig, or fixture at this assembly station.

For example, the computer system can automatically: ingest virtual models (e.g., 3D CAD models) of a part, assembly, part dispenser, and/or assembly station; calculate a 3D end effector geometry capable of retaining a part and avoiding collision with the dispenser and the assembly when moving the part between the dispenser and the assembly; and then queue this 3D end effector geometry for additive manufacturing, such as within seconds of an operator loading these virtual models at an operator portal and specifying an action at this assembly station (i.e., locating the part on the assembly). A 3D printer or other additive manufacturing system can then manufacture an end effector according to this 3D end effector geometry. Upon completion of this end effector—such as within minutes or hours of first loading virtual models and specifying the action at an operator portal—the operator may install this end effector onto the robotic arm, confirm a fixed or responsive path of the end effector between the dispenser and an assembly at the assembly station, and initiate autonomous execution of the specified action by the robotic arm, including interfacing with units of the part via the end effector.

Therefore, the computer system can execute Blocks of the method S100 to enable rapid configuration of a robotic arm to perform an action with parts, assemblies, dispensers, etc. at an assembly station via automatic generation of an end effector for a unique combination of part, assembly, dispenser, and action at an assembly station.

### 3. Robotic Arm

The method S100 is described herein as executed by a computer system to automatically generate an end effector for a transient installation on a robotic arm to enable the robotic arm to interface with a part and/or assembly at an assembly station. The robotic arm can include multiple actuatable joints interposed between multiple beam sections and independently manipulatable to move an end effector mounted to a far end of the robotic arm. Each joint can define one or more actuatable axes driven by an internal actuator (e.g., a servo motor) or by a remote actuator, such as a gearhead motor arranged in a base of the robotic arm and coupled to the joint by a set of tensioned cables. Throughout operation, the system can selectively actuate these joints to move the end effector through a trajectory to engage, move, or otherwise interact with a target object or surface. In particular, the end effector can include an interaction surface configured to engage, contact, modify, or otherwise interact with an external target object or external target surface within a working volume of the robotic arm, and the system can manipulate the joints to move the interaction surface into and out of contact with these target objects and/or target surfaces and to move the interaction surface between such target objects and/or target surfaces.

### 4. Interaction Surface

Block S110, S112, S120, and S122 of the method S100 recite: accessing a virtual model of an assembly and the part; identifying a set of unobstructed surfaces on the part when located in the assembly based on the virtual model; selecting a target surface, from the set of unobstructed surfaces, on the part; and calculating a virtual interaction surface that spans the target surface on the part defined in the virtual model. Generally, in Blocks S110, S112, S120, and S122, the computer system can define an interaction surface (or a set of interaction surfaces) for engaging a part based on features of the part, the assembly, a dispenser, etc. defined in one or more models of the part, assembly dispenser station, and/or assembly station.

### 4.1 Data Ingest

In one implementation, the computer system accesses CAD models and/or other virtual representations for the part, assembly, dispenser, and/or assembly station uploaded at an operator portal executing on a local device (e.g., a desktop computer, a tablet) by an operator. Alternatively, the computer system can retrieve these CAD models from a remote database responsive to selection by the operator.

### 4.2 Available Part Surfaces

The computer system can then prompt the operator to manually identify the part for location on the assembly by a robotic arm at the assembly station, such as by selecting the part in the CAD model of the assembly. Alternatively, the computer system can automatically identify the part based on a difference between a pre- and post-assembly CAD model of the assembly or based on a difference between a pre- and post-assembly configuration in the CAD model of the assembly.

The computer system can then scan the assembly (i.e., the CAD model of the assembly) for surfaces of the part not obscured by other surfaces or objects in the assembly. For example, the computer system can: generate a part mesh representing the part and an assembly mesh representing the assembly (e.g., with an average or target width of one millimeter per mesh element in these meshes) based on the CAD model of the assembly; and calculate rays extending outwardly from and normal to each mesh element in the part mesh. If the computer system thus determines that a ray—extending from a mesh element in the part mesh—intersects the assembly mesh in less than a minimum threshold distance (e.g., four millimeters, or a minimum interaction surface feature thickness), the computer system can mark this mesh element in the part mesh as “obscured” by the assembly. Alternatively, if the computer system determines that a ray—extending from a mesh element in the part mesh—does not intersect the assembly mesh within a maximum threshold distance (e.g., 10o millimeters), the computer system can mark the particular mesh element in the part mesh as “full-access.” Similarly, if the computer system determines that a ray—extending from a mesh element in the part mesh—intersects the assembly mesh between the minimum and maximum threshold distances, the computer system can mark the particular mesh element in the part mesh as “partial-access.” The computer system can repeat this process for each mesh element in the part mesh.

The computer system can then: aggregate contiguous clusters of mesh elements labeled as “obscured” and define corresponding regions on the part as “obscured”; aggregate contiguous clusters of mesh elements labeled as “full access” and define corresponding regions on the part as “full access”; and aggregate contiguous clusters of mesh elements labeled as “partial access” and define corresponding regions on the part as “partial access.”

However, the computing device can implement any other method or technique to identify and label surfaces on the part as obscured, partial access, and/or full access, etc.

### 4.3 Assembly Type and Assembly Axis

The computer system can also characterize the location of the part on the assembly as either placement or insertion based on distribution of obscured and accessible surfaces on the part.

In one example, if “obscured” mesh elements on the part define two (or more) perpendicular surfaces on the part (e.g., a bottom and a side of the part), the computer system can flag the part as an insertion-type part. Accordingly, the computer system can: identify a top of the part defined by a “full-access” mesh elements; identify a bottom of the part opposite the top of the part; aggregate a subset of “obscured” (and “partial-access”) mesh elements between the top and the bottom of the part; and calculate an assembly axis that minimizes distance between the assembly axis and each mesh element in this subset of “obscured” (and “partial-access”) mesh elements.

Alternatively, if obscured mesh elements on the part fall on one approximately-continuous surface (e.g., a bottom of the part) abutting a surface of the assembly, the computer system can mark the part for placement on the assembly. Accordingly, the computer system can: identify a top of the part defined by “full-access” mesh elements; identify a bottom of the part opposite the top of the part and/or abutting the adjacent surface of the assembly; and calculate an assembly axis normal to the adjacent surface of the assembly.

In this implementation, the computer system can also define an assembly direction along the assembly axis. For example, the computer system can isolate an assembly direction—along the assembly axis—that avoids intersection or interference between the part and the assembly when the part is animated along the assembly axis and along the assembly direction toward its final position on the assembly.

The computer system can also calculate a clearance plane for the assembly above which the part, end effector, and robotic arm will not (or is unlikely to) collide with the assembly. For example, the computer system can: calculate a clearance plane normal to the assembly axis; snap the clearance plane to a highest feature on the assembly above the final location of the part on the assembly (or offset above this highest feature on the assembly by a buffer distance, such as five millimeters).

### 4.4 Assembly Axis Verification

In one implementation, the computer system can also interface with the operator portal to render virtual representation of the assembly and the part for the operator and to prompt the operator to confirm the foregoing parameters calculated by the computer system. For example, the operator portal can: highlight surfaces of different types on the virtual representation of the part (e.g., “full-access” surfaces in green; “partial access” surfaces in yellow; “obscured” surfaces in red); and render the assembly axis extending from the virtual representation of the assembly and extending opposite the assembly direction. Alternately, the operator portal can animate the virtual representation of the part moving along the assembly axis toward the virtual representation of the assembly, such as: from a start position in which the bottom surface (or lowest-most point or surface) of the part is located at the clearance plane; and to the end position of the part defined by the post-assembly CAD model or configuration of the assembly. In this example, the operator can then prompt the operator to confirm the assembly axis, the assembly direction, “full-access” surfaces, “partial-access” surfaces, and/or “obscured” surfaces thus depicted in the operator portal.

The operator portal can then interface with this operator to: raise the clearance plane or increase an offset distance above a highest point over the assembly; reverse the assembly direction; and/or move a vertex of the assembly axis at either the surface of the assembly or at the clearance plane, thereby tilting the assembly axis from a default orientation normal to the assembly at the part location. The operator portal can also enable the operator to add and manipulate vertices along the assembly axis and thus redefine the assembly axis as an assembly arc (e.g., a smooth or faceted arc), such as to define both vertical and lateral movement of the part—along this assembly arc—to insert or place the part on the assembly.

The computer system can then access and record confirmation or adjustments thus entered by the operator at the operator portal.

### 4.5 Part Retention Mode

The operator portal can also prompt the operator to select a part retention mode for the end effector to retain the part, such as by selecting one of: a vacuum retention mode; a magnet coupling mode; or a mechanical cincture mode

### 4.5.1 Vacuum Retention

Alternatively, the computer system can default to vacuum retention by the end effector, verify that vacuum retention of the part is feasible, and then elect an alternative part retention mode if vacuum retention is not feasible. In one example, the computer system can: extract a mass and a center of mass of the part from the CAD model; identify a largest full-access surface on the part; label this largest full-access surface as a target surface on the part; and extract a surface area of target surface from the CAD model; extract a surface texture specification (e.g., an arithmetical mean roughness or “Ra” value) of the target surface from the CAD model. The computer system can then: retrieve a vacuum force per unit area value for vacuum end effectors for the surface texture of the target surface, such as stored in a database or table and limited by porosity of 3D-printed structures; and calculate a ratio of the mass of the part to the surface area of the target surface. If this ratio exceeds the vacuum force per unit area value (with a safety factor), the computer system can determine that vacuum retention is insufficient for holding the part and elect a different retention mode for the part accordingly.

Otherwise, the computer system can calculate: a first torque across the target surface as a function of the mass and center of mass of the part; and a second torque applied across the target surface by an adjacent interaction surface on the end effector when vacuum is drawn on the end effector based on the area and position of the target surface and the vacuum force per unit area value. If the first torque exceeds the second torque, the computer system can determine that vacuum retention is insufficient for holding the part and elect a different retention mode for the part accordingly.

Alternatively, if the first torque exceeds the second torque, the computer system can: identify a next-largest full- or partial-access surface—adjacent and non-parallel to the target surface—on the part; label this surface as a second target surface on the part; calculate a third torque applied across the second target surface by an second, adjacent interaction surface on the end effector when vacuum is drawn on the end effector. If the first torque exceeds the sum of the second and third torques, the computer system can elect a different retention mode.

Otherwise, if the second torque (or the sum of the second and third torques) exceeds the first torque, the computer system can confirm vacuum retention for the part and flag the target surface (or both the target surface and the second target surface) for vacuum retention by the interaction surface.

In this implementation, the computer system can also select additional locating surfaces on the part—from a set of full- and/or partial-access surfaces on the part—for contact with datums defined on the interaction surface of the end to repeatably locate the part on the end effector. For example, if the computer system selects a single target surface for vacuum retention by the end effector, the computer system can select: second- and third-largest surfaces—from the set of full- and partial-access surfaces on the part—that are non-parallel to one another and to the target surface, with preference for full-access surfaces; label these surfaces as locating surfaces; and define datums on the interaction surface to repeatably locate these locating surfaces in six degrees of freedom relative to the end effector, as described below. Alternatively, if the computer system selects two target surfaces on the part for vacuum retention, the computer system can: select a next-largest surface—from the set of full- and partial-access surfaces on the part—that is non-parallel to the first and second target surfaces, with preference for full-access surface; label this surface as a locating surface; and define a datum on the interaction surface to locate this locating surface, as described below.

### 4.5.2 Magnetic Retention

Alternatively, if the computer system thus elects a different retention mode for the part, the computer system can first verify that the part is ferrous or magnetic based on a material specification for the part in the CAD model (or bill of materials for the assembly, etc.). If the CAD model specifies that the part is ferrous, the computer system can: estimate a minimum magnetic field strength needed to retain the part based on the mass, material, and material distribution of the part; and query a table or database for a magnetic element (e.g., a permanent magnetic, an electromagnetic) capable of generating the minimum magnetic field strength. If this magnetic element is available, the computer system can confirm magnetic retention of the part.

Accordingly, the computer system can implement methods and techniques described above to isolate target and locating surfaces on the part target, such as largest contiguous full- and partial-access surface on the part.

### 4.5.3 Mechanical Cincture

However, if the computer system determines that vacuum and magnetic retention are not viable for the part, the computer system can instead elect mechanical cincture (e.g., a “gripper”) for engaging and retaining the part.

In one implementation, the computer system: identifies a set of (e.g., two or more) opposing and approximately parallel full- and/or partial-access surfaces defining large or largest surface areas on the part; defines a parting plane between these surfaces; and labels these surfaces as target surfaces—between the parting plane—for mechanical cincture.

### 4.5.4 Combination Retention

In one variation, if the computer system determines that vacuum retention is not sufficient to retain the part, the computer system can elect a combination of vacuum, magnetic, and/or mechanical cincture for the part. The computer system can then implement the foregoing methods and techniques in combination to define target and locating surfaces on the part for these retention methods.

### 4.5.4 Retention Confirmation

The computer system can then interface with the operator via the operator portal to confirm or modify the retention mode, target surfaces, and locating surfaces thus selected automatically by the computer system.

### 4.6 Interaction Surface Generation

The computer system can then generate a virtual representation of the interaction surface for the part based on target and locating surfaces thus selected on the part.

In one implementation, the computer system generates a continuous interaction surface that spans the target and locating surfaces selected for the part and that falls directly on these surfaces of the part in a “nominal” geometry or “nominal” configuration. In this implementation, the computer system can also offset this interaction surface from the surface of the part according to maximal tolerances of the part indicated in the CAD model in order to ensure that an end effector manufactured according to this interaction surface may repeatably locate even units of the part at the edge of permitted tolerances for this part.

In another implementation, the computer system: deforms the 3D model of the part to generate a virtual representation of the largest volume of the part possible according to maximal tolerances of the part indicated in the CAD model; and calculates a contiguous interaction surface that spans target and locating surfaces of the part represented in this deformed 3D model of the the part.

In the variation described above in which the computer system (or the operator) elects mechanical cincture retention for the part, the computer system can also: locate the parting plane relative to the interaction surface; and split the interaction surface along the parting plane to form two adjacent and discrete (or “disjoint”) interaction surfaces.

### 4.7 Interaction Surface Adjustment for Kinematic Location

In one variation, the computer system also deforms the interaction surface(s) in regions abutting locating surfaces on the part in order to define kinematic datums—on the interaction surface—for repeatably locating the part.

In one example, if the part defines a rectilinear geometry, the computer system can: preserve a planar interaction surface region across a planar top surface of the part; deform a first planar interaction surface region along a first locating surface of the part to form a line contact or two point-contacts (e.g., 0.5-millimeter-wide point contacts, or the resolution of an additive manufacturing process) abutting the first location surface on the part; and deform a second planar interaction surface region along a second locating surface of the part to form a single point-contact abutting the second location surface on the part. In particular, the computer system can recess or “relieve” regions of the interaction surface around these locating surfaces on the part such that the interaction surface includes regions approximating a plane (e.g., abutting the target surface on the part), a line contact (e.g., abutting a first locating surface on the part), and a point contact (e.g., abutting a second locating surface on the part).

In another example, if the part defines a cylindrical geometry, the computer system can: preserve a planar interaction surface region across the planar top surface of the part; and deform a cylindrical interaction surface region along a cylindrical locating surface of the part to form two point-contacts radially offset by 120° and abutting the cylindrical locating surface on the part.

Similarly, if the part defines a hemispherical geometry, the computer system can deform the interaction surface along the target surface on the part to form three point-contacts radially offset by 120° and abutting the target surface on the top of the part.

### 5. Assembly Environment and Part Dispenser

In one variation, the computer system can also access a CAD model or other virtual representation of features within the assembly station, such as including: a location and geometry of a part dispenser (e.g., a vibratory dispenser) relative to the robotic arm; and a geometry of features on the dispenser that locate units of the part. The computer system can then: implement methods and techniques similar to those described above to identify obscured, partial-access, and full-access surfaces on a unit of the part when dispensed by the dispenser; and confirm that all target and locating surfaces selected for the part based on installation of the part in the assembly are also partial- or full-access surfaces when dispensed by the dispenser. If not, the computer system can: select an alternative set of target and/or locating surfaces on the part that are partially- or fully-accessible both when located at the dispenser and when assembled on the assembly; and then recalculate the interaction surface accordingly.

The computer system can implement similar methods and techniques to confirm or modify the interaction surface for the part based on a 3D model of a tray configured to store units of the part at the assembly station.

### 6. Interaction Surface to Base Geometry Location

Blocks S130, S140, and S150 of the method S100 recite: locating a virtual end effector base geometry relative to the virtual interaction surface; generating a virtual intermediate structure extending between the virtual interaction surface and the virtual base structure; and compiling the virtual interaction surface, the virtual intermediate structure, and the virtual end effector base geometry into a three-dimensional end effector model. Generally, after defining the interaction surface, the computer system can: retrieve a virtual representation of an end effector base geometry configured to mate to an end of end effector; locate the end effector base geometry relative to the interaction surface; and construct a virtual solid between the end effector base geometry and the interaction surface to form a 3D representation of an end effector configured to interface the robotic arm to units of the part.

In one implementation, the computer system retrieves a generic 3D model of the end effector base geometry from a database and locates the interaction surface for the part relative to the end effector base geometry by: aligning the assembly axis—ported from the part model onto the interaction surface—described above with a center axis of the end effector base geometry; and then sets the interaction surface at a minimum distance from the end effector base geometry. The computer system can then adjust the position of the end effector base geometry relative to the interaction surface according to other constraints described below.

### 7. Retention Systems

The computer system can then inject retention systems for the selected retention mode between the virtual representations of the interaction surface and the end effector base geometry.

### 7.1 Vacuum System

In the implementation described above in which the computer system elects vacuum retention for the part, the computer system: activates a virtual vacuum bib feature in the end effector base geometry; populates the interaction surface with vacuum ports; injects a virtual 3D vacuum manifold behind these vacuum ports; defines a vacuum line between the vacuum manifold and the vacuum port; and shifts the interaction surface relative to the end effector base geometry to minimize length of the vacuum line while eliminating interference between the vacuum manifold and the end effector base geometry.

In this implementation, the computer system can also set a size and density of vacuum ports across the interaction surface based on the surface area of the target surface(s) on the part, the mass of the part, and a vacuum limit for 3D-printed parts. For example, a heavier part may necessitate greater wall thickness for the end effector at the interaction surface in order to rigidly support the part; greater wall thickness may necessitate larger vacuum ports to limit head loss through these ports. Accordingly, the computer system can define a quantity and diameter of vacuum ports on the interaction surface proportional to a mass of the part. Similarly, the computer system can define a volume of the vacuum manifold proportional to the mass of the part.

Alternatively, rather than define vacuum ports across the interaction surface, the computer system can instead assign additive manufacturing parameters to the interaction surface to achieve a target porosity across the interaction surface to achieve sufficient suction force to retain the part across the interaction surface. For example, the computer system can assign a larger step size or lower print resolution across the interaction surface in order to increase porosity across this interaction surface. Conversely, the computer system can assign a smaller step size or greater print resolution at the vacuum bib, vacuum line, and vacuum manifold in order to decrease (or eliminate) porosity across these features.

### 7.2 Magnetic System

Alternatively, in the implementation described above in which the computer system elects magnetic retention for the part, the computer system can: select a magnetic element sized for a minimum magnetic field necessary to retain the part; retrieve a virtual model of the magnetic element; locate the virtual model of the magnetic element behind the interaction surface; and shift the interaction surface relative to the end effector base geometry to accommodate the magnetic element.

### 7.3 Mechanical Cincture System

Yet alternatively, in the implementation described above in which the computer system elects mechanical cincture retention for the part, the computer system can retrieve a virtual jaw model defining a set of (e.g., two) jaws, such as including: two jaws on a common pivot, two jaws on discrete pivots, a fixed jaw and pivoting jaw, two operable jaws on a common linear slide, or one fixed and one operable jaw on a linear slide; and a jaw actuator (e.g., an electromechanical or pneumatic solenoid) configured to actuate one or both jaws.

The computer system can then: scale the virtual jaw model according to the size and mass of the part; locate a first jaw face on the first jaw adjacent a first interaction surface on a first side of the parting plane calculated for the part; and locate a second jaw face of the second jaw adjacent a second interaction surface on a second side of the parting plane on the part; and shift the interaction surface relative to the end effector base geometry to accommodate this adjusted virtual jaw model.

### 7.4 Other Systems

The computer system can implement similar methods and techniques to locate other features or subsystems—such as an ejector subsystem (e.g., an electromechanical ejector pin), a thermal system (e.g., a heating or cooling unit), or a vibratory system—between the interaction surface and the end effector base geometry. The computer system can also interface with the operator to activate and locate one or more of these systems behind the interaction surface.

### 8. Intermediate Structure

In one implementation in which the computer system elects vacuum retention for the part, once the interaction surface is defined and the end effector base geometry and retention elements are located relative to the interaction surface, the computer system: thickens the interaction surface; thickens vacuum elements; and knits a 3D lattice structure extending between the thickened interaction surface and the base geometry and including support structure for the thickened vacuum elements to form a virtual 3D end effector model.

In a similar implementation in which the computer system elects magnetic retention for the part, the computer system: thickens the interaction surface; and knits a lattice structure extending between the thickened interaction surface and the base geometry and including support structure for the magnetic element to form a virtual 3D end effector model.

Alternatively, in the implementation in which the computer system elects mechanical cincture retention for the part, the computer system extrudes jaw surfaces of jaws in the adjusted virtual jaw model up to the interaction surfaces. The computer system then knits a lattice structure between: the base geometry; the pivot(s), jaw, and/or linear slide of the jaw model; and the jaw actuator to form a virtual 3D end effector model.

However, in the foregoing implementations, the computer system can generate or calculate an intermediate structure in any other solid, organic, biomimetic, lattice, or geometric structure format between the interaction surface and the end effector base geometry.

### 9. Variation: End Effector Trimming for Assembly and Dispenser

In one variation, the computer system: calculates an assembly clearance volume extending from the surface or topology of the assembly around the assembled part and defined relative to the part; and calculates a dispenser clearance volume extending from the surface or topology of the dispenser (or tray, etc.) around a dispensed part located by the dispenser and defined relative to the part. The computer system then: locates the assembly clearance volume relative to the dispenser clearance volume based on features on the part; calculates an intersection of the assembly and dispenser clearance volumes; stores this intersection as a composite clearance volume; trims the surface of the composite clearance volume by a buffer distance (e.g., two millimeters; twice a location tolerance of the robotic arm) to compensate for tolerances, spatial variance, and geometric variance at the assembly and at the dispenser; and smooths the resulting surface of the composite clearance volume. The computer system then: locates the composite clearance volume relative to the virtual 3D end effector model based on features on the part; trims regions of the virtual 3D end effector model that extend beyond the composite clearance volume; and recalculates the intermediate structure to accommodate for these trimmed regions of the virtual 3D end effector model.

Alternatively, the computer system can: locate the composite clearance volume relative to the interaction surface and the end effector base geometry; and then implement methods and techniques described above to calculate an intermediate structure that is located fully inside of this composite clearance volume (including a buffer offset, as described above).

### 10. Variation: Direction Accommodation of Assembly/Dispenser Geometries

In another implementation, the computer system identifies full- and partial-access surfaces on the part that persist both when the part is dispensed at the dispenser and installed on the assembly. The computer system then: selects target and locating surfaces from this set of full- and partial-access surfaces; defines an interaction surface based on these target and locating surfaces on the part; locates the interaction surface within the composite clearance volume described above; defines a virtual vacuum manifold (or magnetic element, mechanical cincture elements) behind the interaction surface and fully inside the clearance volume; calculates a position of the end effector base geometry that falls fully inside the composite clearance volume, that does not intersect the vacuum manifold (or other retention element) or the interaction surface, and that falls at a shortest distance to the interaction surface. Finally, the computer system can: thicken the interaction surface; thicken the vacuum manifold; define vacuum ports across the interaction surface; and knit a 3D lattice structure between the thickened interaction surface and the base geometry and including support structure for the thickened vacuum elements to form a virtual 3D end effector model.

However, the computer system can implement any other method or technique to automatically construct a virtual 3D end effector model for the interfacing the robotic arm to the part.

### 11. Virtual Verification

In one variation, the computer system also virtually tests and validates the virtual 3D end effector model.

In one implementation, the computer system: initializes a virtual environment containing a virtual representation of the robotic arm; loads the virtual 3D end effector model onto the virtual representation of the robotic arm in the virtual environment; loads virtual representations of the assembly, assembly fixture, and part dispenser, etc. according to corresponding locations at the assembly station (e.g., as specified by the operator or in an assembly protocol); and populates the virtual representation of the dispenser with a virtual unit of the part.

The computer system can then access a motion model for the robotic arm and calculate a virtual path of the robotic arm between the virtual part at the virtual dispenser and a target location of the part on the assembly according to motion limitations defined by the motion model. For example, the computer system can calculate a virtual path that includes: a dispenser entry path segment from the dispenser clearance plane and along the assembly axis—relative to the part located in the virtual dispenser—to engage the part; a dispenser exit path segment along the assembly axis—relative to the part located in the virtual dispenser—back up to the dispenser clearance plane to withdraw the part from the virtual dispenser; an assembly entry path segment from the assembly clearance plane and along the assembly axis—relative to the part located in the virtual assembly—to locate the part on the virtual assembly; an assembly exit path segment along the assembly axis—relative to the part located in the virtual assembly—and back up to the assembly clearance plane to withdraw the virtual end effector from the virtual assembly; an assembly intermediate path between the dispenser exit path and the assembly entry path; and a reload intermediate path between the assembly exit path and the dispenser entry path.

Accordingly, the computer system can replay the virtual representation of the robotic arm executing the virtual path within the virtual environment according to the motion model and check for collisions between the part, the virtual 3D end effector model, the virtual dispenser, the virtual assembly, and/or other objects in the virtual environment. Responsive to detecting such a collision, the computer system can trim the virtual 3D model of the end effector to avoid such collisions and retest the end effector model in this virtual environment. Additionally or alternatively, responsive to detecting such a collision, the computer system can: adjust the position of the interaction surface relative to end effector base geometry—such as by rotating or translating the interaction surface relative to the end effector base geometry—to eliminate such collisions; regenerate the virtual 3D end effector model according to his change; retest this revised virtual 3D end effector model for collision in this virtual environment; and repeat this process until the computer system no longer detects such collisions.

Therefore, the computer system can adjust the position of the end effector base geometry relative to the interaction surface to accommodate access limitations at the dispenser and/or assembly, such as due to the geometry and positions of the assembly and the dispenser and motion constraints of the robotic arm.

### 12 Production and Deployment

Once the computer system has generated and validated the virtual 3D end effector model (and received confirmation for this end effector geometry from the operator via the operator portal), the computer system can queue the manufacture of an end effector according to this virtual 3D end effector model. For example, the computer system can generate a print file according to this virtual 3D end effector model and transmit this print file to a job scheduler for printing at a 3D printer or other additive manufacturing system.

Upon completion of this end effector, the operator may: install this end effector on a robotic arm at an assembly station; and load and execute the path described above or interface with the robotic arm,—as described in U.S. patent application Ser. No. 15/707,648, which in incorporated in its entirety by the reference—to record or train a new path for autonomous execution by the robotic arm. The operator may then confirm autonomous operation of the robotic arm, including interfacing with units of the part—entering the assembly station—via the end effector.

### 13. Assembly to Fixture

In one variation, the computer system implements similar methods and techniques to generate an end effector configured to interface the robotic arm to an assembly, such as to enable the robotic arm to retrieve and locate an assembly in a fixture or jig at an assembly station—such as rather than retrieving a part from a dispenser and loading the part onto an assembly.

The computer system can implement similar methods and techniques to programmatically generate virtual 3D representations of tooling (e.g., fixtures, jigs) for retaining parts or assemblies (e.g., at an assembly station, such as based on end effectors previously defined according to the method S100 described herein) and to queue these virtual 3D representations of tooling for additive manufacturing. These 3D-printed tools may then be deployed to assembly stations to locate parts and assemblies as robotic arms—loaded with end effectors similarly defined and manufactured—manipulates these parts assemblies according to actions specified for these assembly stations.

### 14. Multiple Interaction Surfaces

In another variation, the computer system implements methods and techniques described above to calculate multiple interaction surfaces for multiple parts or assemblies, locate these multiple interaction surfaces relative to the end effector base geometry, and define a intermediate structure between these interaction surfaces and the end effector base geometry to form an end effector geometry configured to perform multiple operations with these unique multiple parts or assemblies at one robotic arm station.

For example, the computer system can: define a first interaction surface for retrieving an assembly from a tray, loading the assembly into a fixture, and returning the assembly to this tray; and define a second interaction surface for retrieving a part from a dispenser and locating the part on an assembly while the assembly is located in the fixture. In this example, the computer system can: locate the first interaction surface extending from a first side of the end effector; locate the second interaction surface extending from the opposing side of end effector; and define sets of vacuum ports on both the first and second interaction surfaces and coupled to a common vacuum manifold. Thus, once this end effector is fabricated according to the virtual 3D end effector model thus generated by the computer system and installed on the robotic arm, the robotic arm can manipulate both units of the assembly and units of the part—via the single end effector—at the assembly station by selectively rotating the end effector to face the first side of the end effector to face units of the assembly and to face the second side of the end effector to face units of the part.

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method for autonomously generating an end effector for interfacing with a part at a manufacturing station comprising:
accessing a virtual model of an assembly and the part;
based on the virtual model, identifying a set of unobstructed surfaces on the part when located in the assembly;
selecting a target surface, from the set of unobstructed surfaces, on the part;
calculating a virtual interaction surface that spans the target surface on the part defined in the virtual model;
locating a virtual end effector base geometry relative to the virtual interaction surface;
generating a virtual intermediate structure extending between the virtual interaction surface and the virtual base structure;
compiling the virtual interaction surface, the virtual intermediate structure, and the virtual end effector base geometry into a three-dimensional end effector model; and
queuing the three-dimensional end effector model for additive manufacturing to form the end effector for installation on a robotic arm when interfacing with units of the part and units of the assembly at the manufacturing station.
